(19) United States
(12) Patent Application Publication
(10) Pub. No.: US 2020/0143294 A1
(43) Pub. Date: May 7, 2020

(54) AUTOMATIC CLASSIFICATION OF REFRIGERATION STATES USING IN AN INTERNET OF THINGS COMPUTING ENVIRONMENT

(71) Applicant: INTERNATIONAL BUSINESS MACHINES CORPORATION, Armonk, NY (US)

(72) Inventors: Niall BRADY, Donadea (IE); Paulito PALMES, Corn Exchange Place (IE); Amadou BA, Marlborough Street (IE)

(73) Assignee: INTERNATIONAL BUSINESS MACHINES CORPORATION, Armonk, NY (US)

(21) Appl. No.: 16/182,905

(22) Filed: Nov. 7, 2018

(51) Int. Cl. G06N 99/00; G05B 19/042

(52) U.S. Cl. CPC G06N 99/005; G05B 2219/2654; G05B 19/042

(57) ABSTRACT

Embodiments for implementing intelligent refrigeration state classification in an Internet of Things (IoT) computing environment by a processor. A signal from a single IoT sensor associated with a refrigeration system may be used to assist in automatically classifying refrigeration states according to a training phase and an operational phase.

### CROSS-REFERENCE TO RELATED APPLICATIONS

This application is related to the following Application having Attorney Docket Number P201803798US01, which is filed on even date as the present application.

### BACKGROUND OF THE INVENTION

### Field of the Invention

The present invention relates in general to computing systems, and more particularly to, various embodiments for automatic classification of refrigeration states using a single temperature sensor signal within a refrigeration system an Internet of Things (“IoT”) computing environment using a computing processor.

### Description of the Related Art

In today's society, various refrigeration advances, coupled with advances in technology have made possible a wide variety of attendant benefits, such as increasing the efficiency of refrigeration systems. As computers proliferate throughout aspects of society, additional opportunities continue to present themselves for leveraging technology in refrigeration systems for improving efficiency of health and maintenance of refrigeration cabinets.

### SUMMARY OF THE INVENTION

Various embodiments for intelligent refrigeration state classification in an Internet of Things (IoT) computing environment by a processor are provided. In one embodiment, by way of example only, a method/system for automatic classification of refrigeration states using a single temperature sensor signal within a refrigeration system an IoT computing environment is provided. A signal from a single IoT sensor associated with a refrigeration system may be used to assist in automatically classifying refrigeration states according to a training phase and an operational phase. A plurality of refrigeration state classifiers may be determined for the refrigeration system according to a segregation operation and a machine learning operation in the training phase. The operational phase may be defined to continuously collect temperature data over the selected time period by the IoT sensor, apply a de-noising operation to a plurality of signal disturbances from a plurality of sources, and/or generate a report that automatically tag the refrigeration states for each time series signal for the refrigeration system.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a diagram depicting various user hardware and computing components functioning in accordance with aspects of the present invention;

FIG. 5 is a diagram of a table and graph results from automatic classification of refrigeration states using a single temperature sensor signal within a refrigeration system an Internet of Things (“IoT”) computing environment by a processor, in which various aspects of the present invention may be realized;

FIG. 6 is a block flow diagram of applying a de-noising operation to signal disturbances from opening and closing a refrigeration door in accordance with aspects of the present invention;

FIG. 7 is a flowchart diagram of an exemplary method for automatically classifying refrigeration states using a signal from an Internet of Things (IoT) sensor associated with a refrigeration system by a processor, in which various aspects of the present invention may be realized;

FIG. 8 is a graph diagram of an exemplary method for automatically classifying refrigeration states for a time series signal for the refrigeration system by a processor, in which various aspects of the present invention may be realized;

FIG. 9 is a diagram of results of automatically classifying refrigeration states for a time series signal for the refrigeration system by a processor, in which various aspects of the present invention may be realized; and

FIG. 10 is a flowchart diagram of an exemplary method for implementing intelligent refrigeration state classification in an Internet of Things (IoT) computing environment in accordance with aspects of the present invention.

### DETAILED DESCRIPTION OF THE DRAWINGS

Refrigeration is a process of moving heat from one location to another in controlled conditions. The work of heat transport may be driven by mechanical work, but can also be driven by heat, magnetism, electricity, laser, or other means. Refrigeration has many applications, including, but not limited to: household refrigerators, industrial freezers, cryogenics, and air conditioning. Heat pumps may use the heat output of the refrigeration process, and may be designed to be reversible, but are otherwise similar to air conditioning units.

Understanding the different refrigeration states and current state is a core element of determining system health through proper application of analytics. Central to the present invention, as describe herein, relates to the notion of determination of the refrigeration states during normal operation with a single temperature signal showing the various refrigeration states system normally operate within, namely a defrost (DEF) state, defrost recovery (DR) state, and/or steady state (SS) (i.e., a normal or standardized temperature control operation).

Currently, approaches to determining a refrigeration state are performed by interrogation of the refrigeration system controller where a user may extract critical parametric data such as, for example, a defrost status flag, evaporator valve, defrost termination temperature, calculated product temperature, and air off temperature, to determine a refrigeration state. However, availability and access of the underlying refrigeration parametric data is a current industry challenge because the refrigeration parametric data in not readily available, or non-existent due to a myriad of reasons such as, for example, in efficient legacy hardware and non-standard communication protocols, infrastructure deficits, and the closed non-sharing industry proprietary environments.

As a result, the inability to determine accurately and automatically determine the current refrigeration state has limited the application of followon analytic services needed to ascertain ongoing system health and inhibits widescale deployment of analytic services. In one aspect, the followon analytic services may include using a derived defrost state to aggregate a number of defrosts per day per refrigeration cabinet over a selected time period that can then be used to establish if a particular refrigeration cabinet is running excessive defrosts cycles with respect to a policy and thus using excessive energy.

As such, a need exists for intelligent refrigeration state classification in an Internet of Things (IoT) computing environment. In one embodiment, by way of example only, the present invention provides for automatic classification of refrigeration states using a single temperature sensor signal within a refrigeration system an Internet of Things (“IoT”) computing environment is provided. A signal from a single IoT sensor associated with a refrigeration system may be used to automatically classifying refrigeration states according to a training phase and an operational phase. A plurality of refrigeration state classifiers may be determined for the refrigeration system according to a segregation operation and a machine learning operation in the training phase. The operational phase may be defined to continuously collect temperature data over the selected time period by the IoT sensor, apply a de-noising operation to a plurality of signal disturbances from a plurality of sources, and/or generate a report that automatically tag the refrigeration states for each time series signal for the refrigeration system.

In one aspect, the present invention pertains to establishing a refrigeration system (e.g., a refrigeration cabinet) defrost performance position in the absence of underlying parametric control data, which is not readily available. A combination of numerical operations and artificial intelligence (“AI”) may be used to automatically classify refrigeration states using only a single IoT enabled single low cost temperature sensor (e.g., independent and non-dependent on refrigerator controller data access), which will enable application of followon analytic services that can be applied at scale and offers a user a cost effective means that may be applied at scale to identify performance anomalies. The present invention provides for continuous refrigeration system health assessment, allows a user to validate defrost schedules at scale, and enables automatic application of followon analytics to determine ongoing refrigerator operational health. The present invention may use refrigeration controller data that is available to allow for automatic classification of refrigeration states and enable followon analytic services.

Additional aspects of the present invention and attendant benefits will be further described, following.

In an additional aspect, as used herein, cognitive or “cognition” may refer to a mental action or process of acquiring knowledge and understanding through thought, experience, and one or more senses using machine learning (which may include using sensor based devices or other computing systems that include audio or video devices). Cognitive may also refer to identifying patterns of behavior, leading to a “learning” of one or more events, operations, or processes. Thus, the cognitive model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term cognitive may refer to a cognitive system. The cognitive system may be a specialized computer system, or set of computer systems, configured with hardware and/or software logic (in combination with hardware logic upon which the software executes) to emulate human cognitive functions. These cognitive systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. A cognitive system may perform one or more computer-implemented cognitive operations that approximate a human thought process while enabling a user or a computing system to interact in a more natural manner. A cognitive system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such cognitive systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) High degree of relevant recollection from data points (images, text, voice) (memorization and recall); and/or 13) Predict and sense with situational awareness operations that mimic human cognition based on experiences.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, tablets, and the like).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

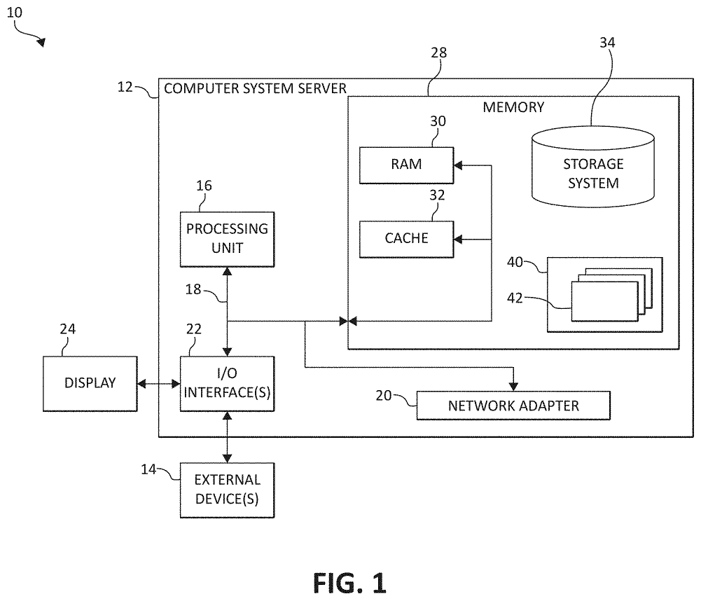

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in a moving vehicle. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

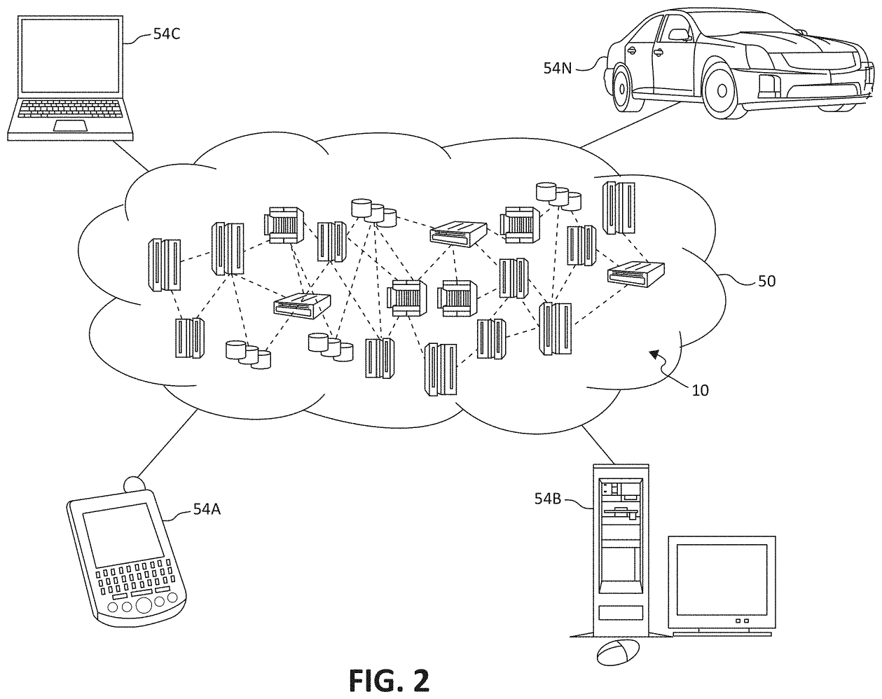

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

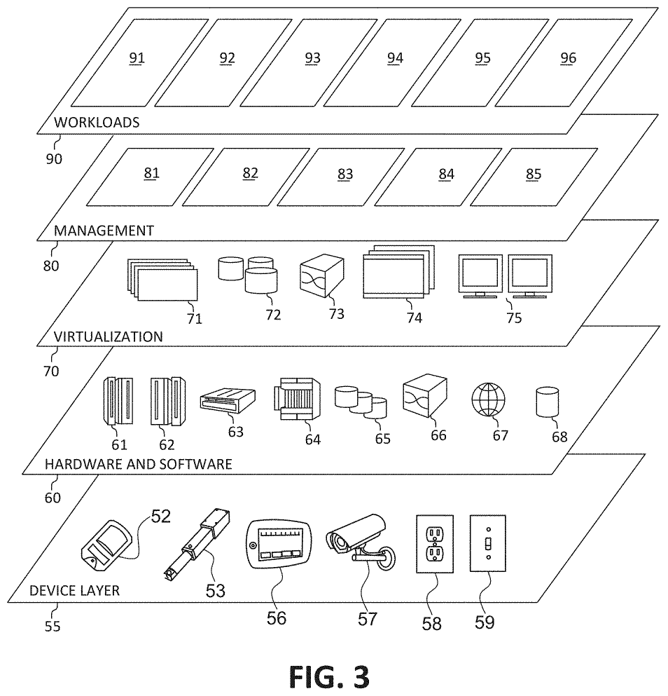

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for intelligent automatic classification of refrigeration states using a single temperature sensor signal within a refrigeration system an IoT computing environment. In addition, workloads and functions 96 intelligent automatic classification of refrigeration states using a single temperature sensor signal within a refrigeration system an IoT computing environment may include such operations as data analysis (including data collection and processing from various environmental sensors), and predictive data analytics functions. One of ordinary skill in the art will appreciate that the workloads and functions 96 for intelligent automatic classification of refrigeration states using a single temperature sensor signal within a refrigeration system an IoT computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

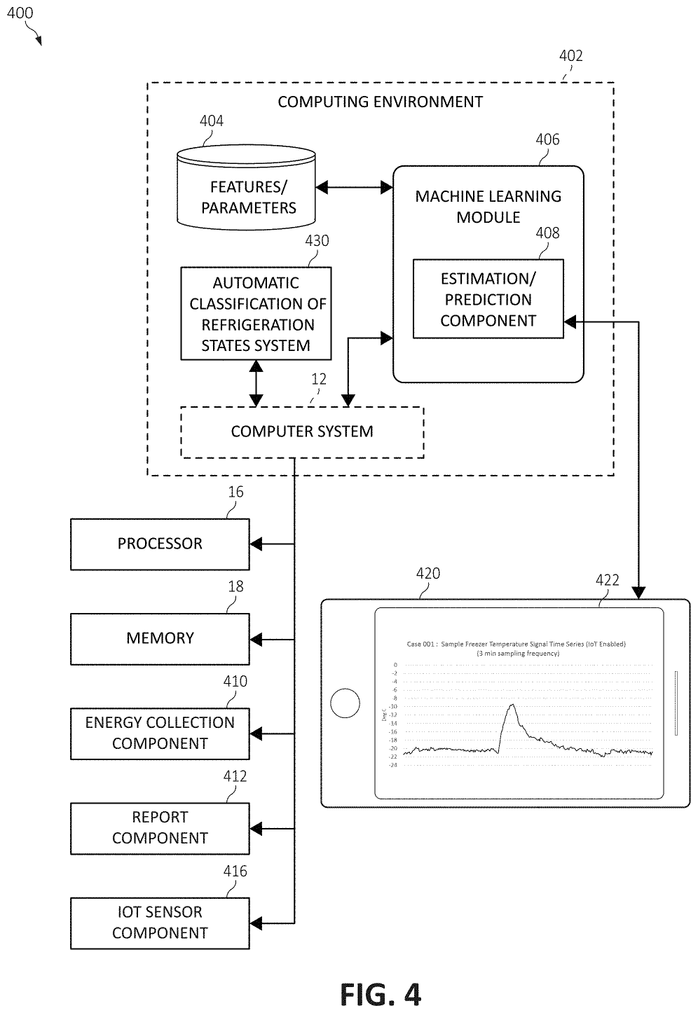

Turning now to FIG. 4, a block diagram depicting exemplary functional components 400 according to various mechanisms of the illustrated embodiments is shown. FIG. 4 illustrates intelligent automatic classification of refrigeration states using a single temperature sensor signal within a refrigeration system a computing environment, such as a computing environment 402 (e.g., an IoT computing environment), according to an example of the present technology. As will be seen, many of the functional blocks may also be considered “modules” or “components” of functionality, in the same descriptive sense as has been previously described in FIGS. 1-3. With the foregoing in mind, the module/component blocks 400 may also be incorporated into various hardware and software components of a system for accurate temporal event predictive modeling in accordance with the present invention. Many of the functional blocks 400 may execute as background processes on various components, either in distributed computing components, or on the user device, or elsewhere. Computer system/server 12 is again shown, incorporating processing unit 16 and memory 28 to perform various computational, data processing and other functionality in accordance with various aspects of the present invention.

The system 400 may include the computing environment 402 (e.g., included in a heat exchange system/unit), an automatic classification of refrigeration states system 430, and a device 420, such as a desktop computer, laptop computer, tablet, smart phone, and/or another electronic device that may have one or more processors and memory. The device 420, the automatic classification of refrigeration states system 430, and the computing environment 402 may each be associated with and/or in communication with each other, by one or more communication methods, such as a computing network. In one example, the device 420 and/or the automatic classification of refrigeration states system 430 may be controlled by an owner, customer, or technician/administrator associated with the computing environment 402. In another example, the device 420 and/or the automatic classification of refrigeration states system 430 may be completely independent from the owner, customer, or technician/administrator of the computing environment 402.

In one aspect, the computing environment 402 may provide virtualized computing services (i.e., virtualized computing, virtualized storage, virtualized networking, etc.) to devices 420. More specifically, the computing environment 402 may provide virtualized computing, virtualized storage, virtualized networking and other virtualized services that are executing on a hardware substrate.

As depicted in FIG. 4, the computing environment 402 may include a machine learning module 406, features and/or parameters 404 that are associated with a machine learning module 406, and the automatic classification of refrigeration states system 430. The features and/or parameters database 404 may also include current and/or historical data related to temperatures and refrigeration characteristics of each type of refrigeration system (e.g., a refrigeration cabinet in a store, etc.) for the automatic classification of refrigeration states system 430 and/or IoT sensor devices associated with an IoT sensor component 416. It should be noted that one or more IoT sensor devices may be represented as the IoT sensor component 416 may be coupled to the automatic classification of refrigeration states system 430. The features and/or parameters 404 may be a combination of features, parameters, behavior characteristics, temperature data, energy usage data, defrost state data, defrost recovery state data, steady state data, historical data, tested and validated data, or other specified/defined data for testing, monitoring, validating, detecting, learning, analyzing and/or calculating various conditions or diagnostics relating to cognitively assessing thermal energy in the automatic classification of refrigeration states system 430. That is, different combinations of parameters may be selected and applied to the input data for learning or training one or more machine learning models of the machine learning module 406. The features and/or parameters 404 may define one or more settings of one or more IoT sensors associated with the IoT sensor component 416.

The computing environment 402 may also include a computer system 12, as depicted in FIG. 1. The computer system 12 may also include the energy collection component 410, a report generation component 412, and an IoT sensor component 416 each associated with the machine learning module 406 for training and learning one or more machine learning models and also for applying multiple combinations of features, parameters, behavior characteristics, temperature data, or a combination thereof to the machine learning model for automatically classifying refrigeration states using a single temperature sensor signal within a refrigeration system.

In one aspect, the machine learning module 406 may include an estimation/prediction component 408 for cognitively training, estimating, learning, and/or classifying refrigeration states using a single temperature sensor signal within a refrigeration system, by an IoT sensor associated with the IoT sensor component 416 located at a selected location of a refrigeration system in the automatic classification of refrigeration states system 430.

The machine learning module 406 may collect feedback information from the one or more IoT sensors associated with the IoT sensor component 416 to learn and classify refrigeration states of the automatic classification of refrigeration states system 430. The machine learning module 406 may use the feedback information to automatically learn and classify refrigeration states of the refrigeration states system 430.

The energy collection component 410 (e.g., a temperature collection) may process, analyze, and/or use the collected data from the from the one or more IoT sensors associated with the IoT sensor component 416. The energy collection component 410 may collect temperature time series data from one or more additional IoT sensors associated with the IoT sensor component 416 for both a refrigeration system (e.g., a refrigeration cabinet) being unsealed and the refrigeration system being sealed.

The automatic classification of refrigeration states system 430 may automatically classify refrigeration states using a signal from an IoT sensor component 416 associated with a sensor of a refrigeration system (e.g., a refrigeration cabinet) according to a training phase and an operational phase. The automatic classification of refrigeration states system 430 may determine a plurality of refrigeration state classifiers for the refrigeration system according to a segregation operation and a machine learning operation in the training phase. The automatic classification of refrigeration states system 430 may define the plurality of refrigeration state classifiers to include a defrost state, a defrost recovery state, and a steady state.

The automatic classification of refrigeration states system 430 may define the operational phase to 1) continuously collect temperature data over the selected time period by the IoT sensor associated with the IoT sensor component 416, 2) apply a de-noising operation to a plurality of signal disturbances from a plurality of sources, and 3) generate a report, via the report generation component 412, that automatically tags the refrigeration states for each time series signal for a refrigeration system.

The automatic classification of refrigeration states system 430 may compare one or more of the plurality of refrigeration state classifiers to defined refrigeration classification states and determine one or more refrigeration anomalies according to the comparing. The automatic classification of refrigeration states system 430 may filter one or more known external events having possible negative impact upon a temperature signal of the refrigeration system.

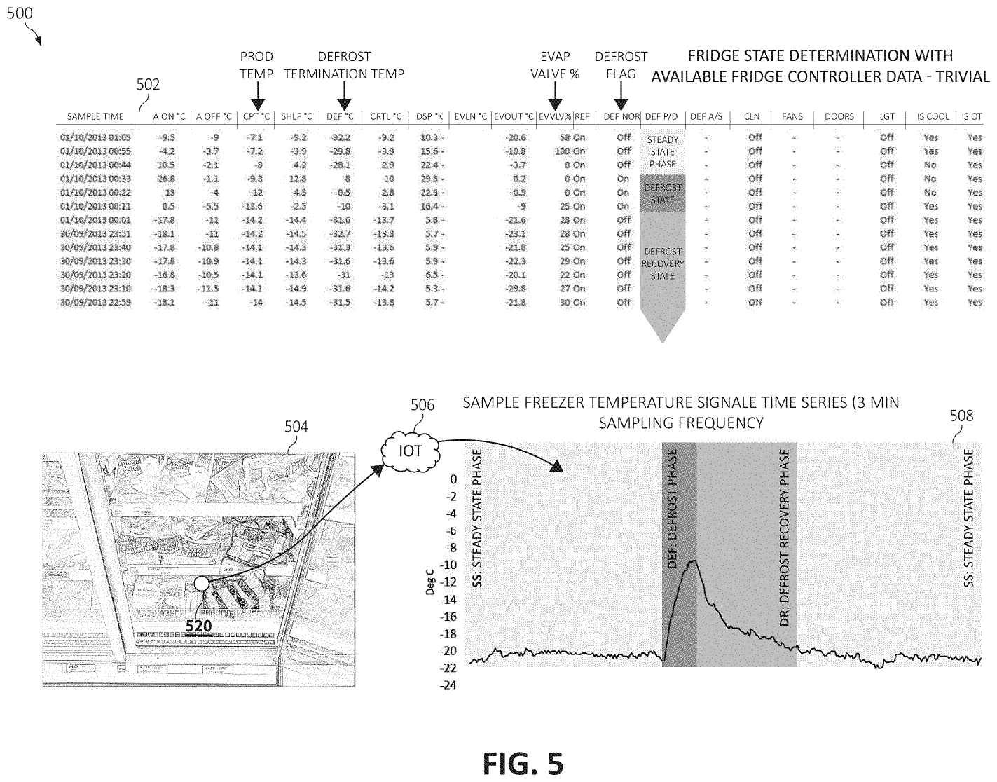

The device 420 may include a graphical user interface (GUI) 422 enabled to display on the device 420 one or more user interface controls for a user to interact with the GUI 422. For example, the GUI 422 may display the report tags the refrigeration states for each time series signal for a refrigeration system. Also, the GUI 422 may display a graph (see graph 508 of FIG. 5) showing results of a sample freezer temperature signal time series with a determination of the refrigeration states during normal operation with a typical temperature signal presented below showing the various refrigeration states system normally operate within, defrost (DEF), defrost recovery (DR), and steady state (SS).

In one aspect, the machine learning operations of the machine learning module 406, as described herein, may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environement (e.g., external to the controlled, testing environment), the computing devices may be monitored for compliance.

In one aspect, the computing system 12/computing environment 402 may perform one or more calculations according to mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

FIG. 5 is a diagram of a table and graph results from automatic classification of refrigeration states using a single temperature sensor signal within a refrigeration system an Internet of Things (“IoT”) computing environment. As illustrated, a table diagram 502 is depicted with various measurements and refrigeration state determination with available refrigerator control data from a refrigerator 504 (e.g., a refrigerator system/refrigerator cabinets in a market/store) as collected by an IoT sensor 520 in an IoT computing environment 506. For example, table diagram 502 may collect/display sample times, temperatures, production temperatures (e.g., “prod temp”), defrost termination temperatures, evaporation values (e.g., evaporation “evap” value percentages), a defrost flag that may indicate a refrigeration classification (e.g., steady state, defrost state, and/or defrost recovery state).

Using the various aspects of the present invention, assuming no controller data is available, a single IoT enabled temperature sensor (e.g., IoT sensor 520) may be mounted in the refrigerator 504. A signal processing operation (e.g., a non-trivial signal processing operation) may be executed of temperature signal time series to determine different refrigeration state classifications and subsequent anomalous behavior.

Thus, graph 508 may be generated showing results of a sample freezer temperature signal time series with a determination of the refrigeration states during normal operation with a typical temperature signal presented below showing the various refrigeration states system normally operate within, defrost (DEF), defrost recovery (DR), and steady state (SS).

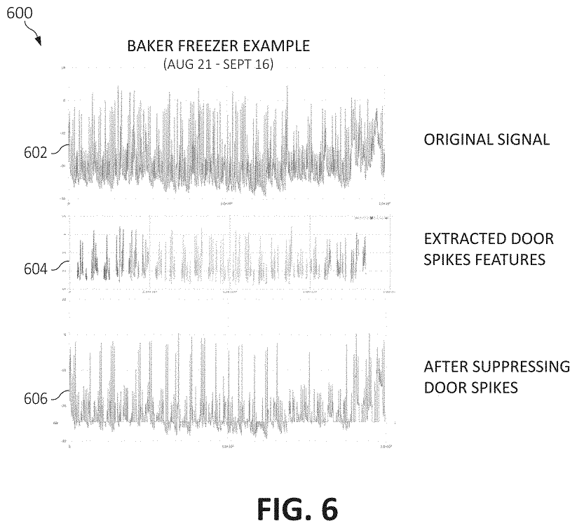

Turning now to FIG. 6, diagram 600 illustrates applying a de-noising operation to signal disturbances from opening and closing a refrigeration door. That is, diagram 600 illustrates how denoising operations have been built and tested relating to refrigeration system door opening such as, for example, in an exemplary freezer of a bakery/store during a defined time period (e.g., August 21-September 16) It should be noted that the de-noising algorithms operations be able to contend and differentiate with a multitude of other sources of noise such as, for example, other non-trivial signal noise impacts present in most real environments (e.g., random door opening events, random fan failures, power glitches, and any other source of operational noise). The denoising operation should be able to contend with other possible sources of noise impacts on signal effects such as, for example, power outages, fan failures, door opening, etc.

As illustrated in diagram 600, an effect of random refrigeration door opening events are depicted and a machine learning operation of the system learning and identifying the signal signatures to differentiate between door opening and defrost events. For example, the various learned signal signatures may be an original signal 602 (e.g., a signal during normal uninterrupted refrigeration operating conditions), signal 604 indicating extracted door spike features, and signal 606 indicating signals generated after suppressing the door spikes of signal 604.

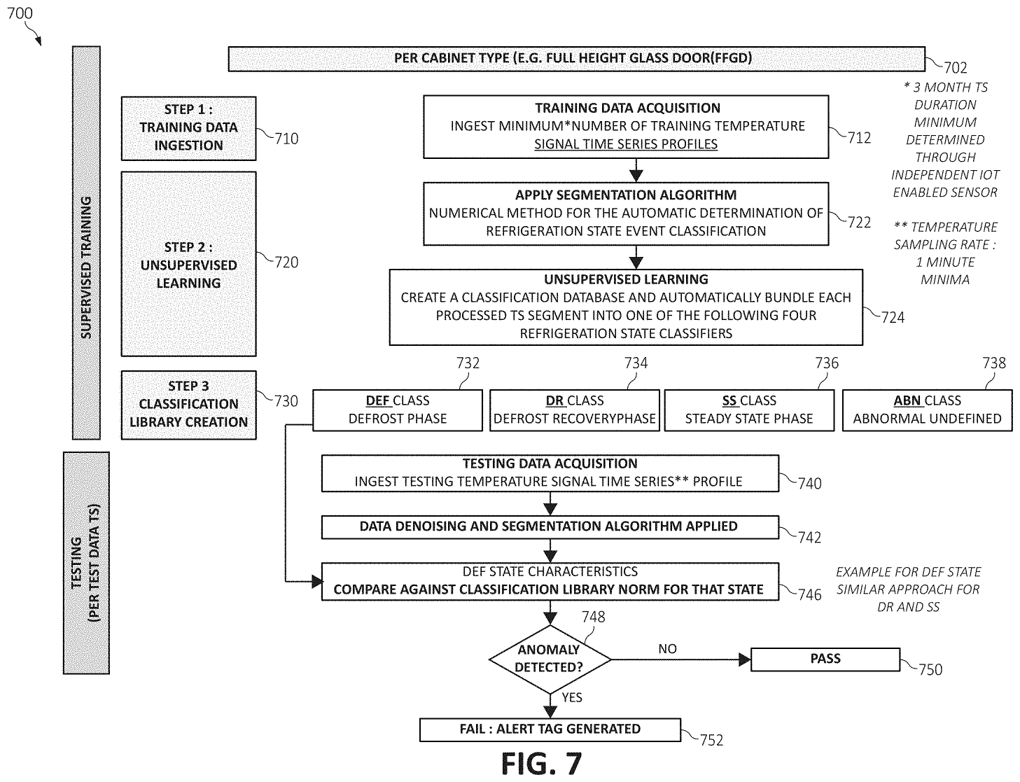

FIG. 7 is a flowchart diagram of an exemplary method for exemplary method for automatically classifying refrigeration states using a signal from an Internet of Things (IoT) sensor associated with a refrigeration system by a processor. The functionality 700 may be implemented as a method executed as instructions on a machine, where the instructions are included on at least one computer readable medium or one non-transitory machine-readable storage medium. The functionality 700 may start in block 702 by data being received (e.g., “input”) from one or more refrigeration systems (e.g., a refrigeration cabinet such as, for example, a full height glass door “FFGD”).

In step 1), training data may be ingested and preprocessed, as in block 710. As part of step 1, training data may be acquired such as, for example, by ingesting a minimum number of training temperature signal time series profiles, as in block 712. (Time series “TS” duration may be for a minimum of a defined period (e.g., three months) and determined through one or more independent IoT enabled sensors).

In step 2) an unsupervised learning operation may be performed, as in block 720. As part of step 2, a segmentation operation (e.g., segmentation algorithm) may be applied such as, for example, by automatically determining a refrigeration state event classification via a numerical method, as in block 722. In one aspect, a temperature sampling rate may occur, for example, at a minimum of every one minute. An unsupervised operation may be performed such as, for example, by creating a classification database and automatically bundle each processed TS segment into one of four refrigeration state classifiers, as in block 724.

In step 3), a classification library may be created, as in block 730. The four refrigeration state classifiers may be classified as a DEF class 732 (e.g., a defrost phase), a DR class 734 (e.g., a defrost recovery phase), a SS class 736 (e.g., steady state phase), ABN class 738 (e.g., an abnormal/undefined phase).

It should be noted that steps 1-3 may be performed in a supervised training environment. Upon completion of the supervised training, a testing operation (per test data TS) may be performed as follows. In block 740, training data may be acquired such as, for example, by ingesting testing temperature signal time series profiles, as in block 740. A data denoising and segmentation operation may be applied, as in block 742. A current DEF state characteristics (e.g., the DEF class 732, the DR class 734, the SS class 736, and/or the ABN class 738) may be compared against a classification library for that particular/identified refrigeration state, as in block 746. That is, a determination operation is performed to determine if the current DEF state characteristics (e.g., the DEF class 732, the DR class 734, the SS class 736, and/or the ABN class 738) matches the particular/identified refrigeration state in the classification library. If In block 748, a determination operation is performed to determine if an anomaly is present based on the comparison. If yes, an alert tag may be generated, as in block 752. If no, a success or “pass” notification may be issued, as in block 750.

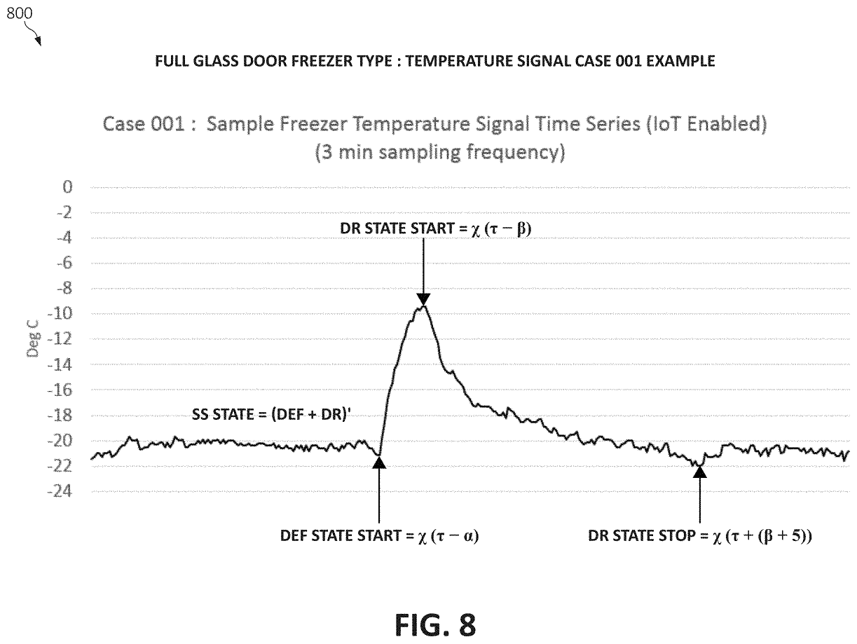

Turning now to FIG. 8, graph 800 of an exemplary method for automatically classifying refrigeration states for a time series signal for the refrigeration system by a processor. That is, graph 800 illustrates temperature signal segmentation for classification of the refrigeration states in a FFGD type refrigeration system showing a SS state, a DEF start state, a DR state start, and a DR state stop.

In one aspect, for the temperature signal segmentation for classification of the refrigeration states, the following pseudocode operation may be performed, with results illustrated in graph 800:

For a given temperature signal (x)(t)

compute Δ(x)(t)=x(t+1)−x(t)

if Δ(x)(t)>0 positive direction,
Δ(x)(t)<0 positive direction
   And α=number of intervals to indicate sustained positive trend,
β=number of intervals to indicate sustained negative trend
   For each timeseries x(t) to x(t+n) where n equals a number of 1 minute intervals, determine state boundaries
   if Δ(x)(t)>0+ϵ for α minutes=DEF state start
=>DEF State Start=x(t−α)
   if Δ(x)(t)<0+ϵ for β minutes=DR state start
=>DR State Start=x(t−β)
=>DR State Start=DEF Start Stop
   if Δ(x)(t)<0+ϵ for β minutes+Δ(x)(t+β)>0 for 5 minutes=DR state start
=>DR State Stop=x(t+(β+5))
=>SS state=(DEF+DR)′.

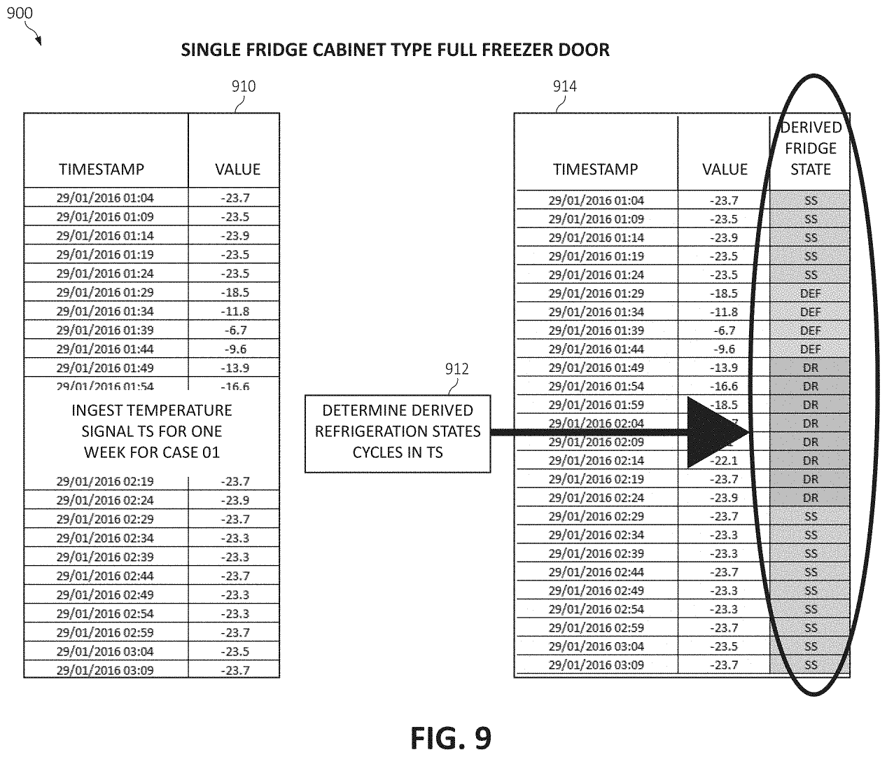

FIG. 9 is a diagram 900 of results of automatically classifying refrigeration states for a time series signal for the refrigeration system (e.g., a FFGD). In one aspect, table 910 of diagram 900 illustrates a timestamp and value of ingested temperature signal TS for a selected time period (e.g., 7 days or “week”) using the same previous examples involving the FFGD. As illustrated in updated table 914, one or more derived refrigeration state cycles in TS may be determined (e.g., derived refrigeration states).

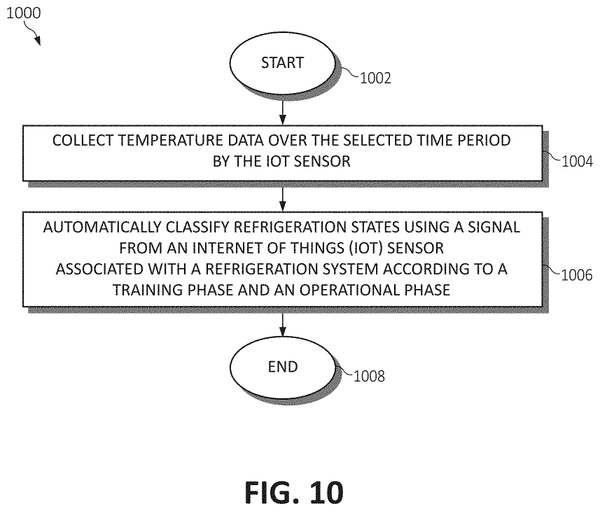

FIG. 10 is a method 1000 for implementing intelligent refrigeration state classification in an Internet of Things (IoT) computing environment. The functionality 1000 may be implemented as a method executed as instructions on a machine, where the instructions are included on at least one computer readable medium or one non-transitory machine-readable storage medium. The functionality 1000 may start in block 1002.

Temperature data may be collected over the selected time period by the IoT sensor, as in block 1004. A signal from a single IoT sensor associated with a refrigeration system according to a training phase and an operational phase, as in block 1006. The functionality 1000 may end in block 1008.

In one aspect, in conjunction with and/or as part of at least one block of FIG. 10, the operations of method 1000 may include each of the following. The operations of methods 1000 may include determining a plurality of refrigeration state classifiers for the refrigeration system according to a segregation operation and a machine learning operation in the training phase. The plurality of refrigeration state classifiers may be defined to include a defrost state, a defrost recovery state, and a steady state.

The operations of methods 1000 may define the operational phase to 1) continuously collect temperature data over the selected time period by the IoT sensor, 2) apply a de-noising operation to a plurality of signal disturbances from a plurality of sources; and/or generate a report that automatically tag the refrigeration states for each time series signal for the refrigeration system.

The operations of methods 1000 may compare one or more of a plurality of refrigeration state classifiers to defined refrigeration classification states; and Determine one or more refrigeration anomalies according to the comparing. The operations of methods 1000 may collect temperature time series data from one or more additional IoT sensors for both the refrigeration system being unsealed and the refrigeration system being sealed. The operations of methods 1000 may filtering one or more known external events having possible negative impact upon a temperature signal of the refrigeration system.

In an additional aspect, the present invention provides for using a signal from a single IoT enabled temperature sensor within an instore refrigerator cabinet when underlying refrigerator controller parametric data is unavailable. The signal from a single IoT enabled temperature sensor within an instore refrigerator cabinet may be used. In a training phase, application of a segregation operation and an unsupervised learning operation may be used to determine the three refrigeration state classifiers for a selected refrigerator cabinet type.

In the operational phase, application of the ML operation that will ingest real-time temperatures signals from all cabinets, apply denoising operations that contend with multiple sources of signal disturbances, noise that must be filtered out in order to classify the refrigeration states, and generate an output report that will automatically tag the cabinet temperature signal timeseries for cabinets within the estate. The identification of anomalies in the various refrigeration estates from an ingested temperature data and real-time data signals can be collected from a refrigerator unit by comparing defined state to that compared to library state norms determined in the training phase. When underlying refrigerator controller parametric data is available, additional IoT enabled sensor data may be used to additionally ingest refrigerator door opening timeseries data, or aisleway temperature sensor timeseries data may be used/classified to improve the accuracy of the operations used for automatic classification of refrigeration states by filtering out known external events that impact the refrigerator temperature signal.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for implementing intelligent refrigeration state classification in an Internet of Things (IoT) computing environment by a processor, comprising:
automatically classifying refrigeration states using a signal from an IoT sensor associated with a refrigeration system according to a training phase and an operational phase.

2. The method of claim 1, further including determining a plurality of refrigeration state classifiers for the refrigeration system according to a segregation operation and a machine learning operation in the training phase.

3. The method of claim 2, further including defining the plurality of refrigeration state classifiers to include a defrost state, a defrost recovery state, and a steady state.

4. The method of claim 1, further including defining the operational phase to:
continuously collect temperature data over the selected time period by the IoT sensor;
apply a de-noising operation to a plurality of signal disturbances from a plurality of sources; and
generate a report that automatically tag the refrigeration states for each time series signal for the refrigeration system.

5. The method of claim 1, further including:
comparing one or more of a plurality of refrigeration state classifiers to defined refrigeration classification states; and
determining one or more refrigeration anomalies according to comparing the one or more of the plurality of refrigeration state classifiers.

6. The method of claim 1, further including collecting temperature time series data from one or more additional IoT sensors for both the refrigeration system being unsealed and the refrigeration system being sealed.

7. The method of claim 1, further including filtering one or more known external events having possible negative impact upon a temperature signal of the refrigeration system.

8. A system for implementing intelligent refrigeration state classification in an Internet of Things (IoT) computing environment, comprising:
one or more computers with executable instructions that when executed cause the system to:
automatically classify refrigeration states using a signal from an IoT sensor associated with a refrigeration system according to a training phase and an operational phase.

9. The system of claim 8, wherein the executable instructions further determine a plurality of refrigeration state classifiers for the refrigeration system according to a segregation operation and a machine learning operation in the training phase.

10. The system of claim 9, wherein the executable instructions further define the plurality of refrigeration state classifiers to include a defrost state, a defrost recovery state, and a steady state.

11. The system of claim 8, wherein the executable instructions further define the operational phase to:
continuously collect temperature data over the selected time period by the IoT sensor;
apply a de-noising operation to a plurality of signal disturbances from a plurality of sources; and
generate a report that automatically tag the refrigeration states for each time series signal for the refrigeration system.

12. The system of claim 8, wherein the executable instructions further:
compare one or more of a plurality of refrigeration state classifiers to defined refrigeration classification states; and
determine one or more refrigeration anomalies according to comparing the one or more of the plurality of refrigeration state classifiers.

13. The system of claim 8, wherein the executable instructions further collect temperature time series data from one or more additional IoT sensors for both the refrigeration system being unsealed and the refrigeration system being sealed.

14. The system of claim 8, wherein the executable instructions further filter one or more known external events having possible negative impact upon a temperature signal of the refrigeration system.

15. A computer program product for implementing intelligent refrigeration state classification in an Internet of Things (IoT) computing environment by a processor, the computer program product comprising a non-transitory computer-readable storage medium having computer-readable program code portions stored therein, the computer-readable program code portions comprising:
an executable portion that automatically classifies refrigeration states using a signal from an IoT sensor associated with a refrigeration system according to a training phase and an operational phase.

16. The computer program product of claim 15, further including an executable portion that determines a plurality of refrigeration state classifiers for the refrigeration system according to a segregation operation and a machine learning operation in the training phase.

17. The computer program product of claim 16, further including an executable portion that defines the plurality of refrigeration state classifiers to include a defrost state, a defrost recovery state, and a steady state.

18. The computer program product of claim 15, further including an executable portion that defines the operational phase to:
continuously collect temperature data over the selected time period by the IoT sensor;
apply a de-noising operation to a plurality of signal disturbances from a plurality of sources; and
generate a report that automatically tag the refrigeration states for each time series signal for the refrigeration system.

19. The computer program product of claim 15, further including an executable portion that:
compares one or more of a plurality of refrigeration state classifiers to defined refrigeration classification states; and
determines one or more refrigeration anomalies according to comparing the one or more of the plurality of refrigeration state classifiers.

20. The computer program product of claim 15, further including an executable portion that:
collects temperature time series data from one or more additional IoT sensors for both the refrigeration system being unsealed and the refrigeration system being sealed; and
filters one or more known external events having possible negative impact upon a temperature signal of the refrigeration system.
